(19) United States
(12) Patent Application Publication
(10) Pub. No.: US 2004/0259050 A1
(43) Pub. Date: Dec. 23, 2004

(54) Verifying apparatus for accuracy of dental cast mounting

(76) Inventors: Michael J. Racich, West Vancouver (CA); Daniel Friedman, North Vancouver (CA)

Correspondence Address: GRAYBEAL, JACKSON, HALEY LLP, 155 - 108TH AVENUE NE, SUITE 350, BELLEVUE, WA, 98004-5901, US

(21) Appl. No.: 10/601,045

(22) Filed: Jun. 20, 2003

(51) Int. Cl. A61C 11/00

(52) U.S. Cl. 433/56; 433/60

(57) ABSTRACT

Apparatus for verifying the interrelationship of upper and lower dental casts of a patient's teeth using a group of interocclusal records. The apparatus comprises a mounting surface with a clamping system to hold one of the upper and lower dental casts in an anchored position in order to receive the other of the dental casts in a supported position with an interocclusal record of the group insertable between the upper and lower dental casts. An indexing system is associated with the mounting surface for marking the dental cast in the supported position with index marks for the dental record. Alternatively, the supported dental cast may be mounted to a second, upper mounting surface and the upper mounting surface is marked with the index marks. The interrelationship of the dental casts is considered accurate if a second interocclusal record of the group results in the same at least three index marks being made to the dental cast in the supported position. The apparatus is inexpensive and configurable into a compact form for ease of storage. The apparatus can be use before or after mounting of the dental casts to an articulator.

### FIELD OF THE INVENTION

This invention relates generally to dental equipment and, more particularly, to an apparatus for verifying the interrelationship and accuracy of mounting and mounted dental casts.

### BACKGROUND OF THE INVENTION

In performing certain types of dental work, such as fitting a patient for dentures, a crown or a bridge, it is common to make plaster casts of the patient's upper and lower teeth to create a model of the patient's mouth to free the dentist from working within the confines of the patient's oral cavity. This model can be worked on by the dentist as desired to produce dental prostheses which can then be fitted into the patient's mouth at a subsequent dental appointment. It is important that the model of the patient's mouth be accurate to ensure that the dental work that is performed on the model is readily transferable to the patient's mouth. It is necessary not only that the plaster dental casts be accurate, but also that the plaster casts are mounted in such a manner as to accurately reproduce the anatomical orientation of the teeth and the movement of the patient's jaw structure. Various dental articulators have been developed that allow for mounting of the dental casts so as to accurately reproduce the orientation and configuration a patient's upper and lower teeth. Examples of such equipment includes articulators as disclosed in U.S. Pat. Nos. 4,024,640 and 5,431,564, both to Niles Guichet, and equipment manufactured by companies such as Panadent Corporation of Grand Terrace, California and Denar Corporation, recently acquired by Teledyne, Inc. of Los Angeles, Calif.

In order to mount the dental casts to the articulation equipment, it is necessary to make dental records, also known as interocclusal records (IORs), of the patient's teeth. These records are used to re-establish the interfit and orientation (i.e. the interrelationship) of the patient's actual teeth between the upper and lower dental casts when the casts are mounted to an articulator. Dental interocclusal records can be made from any material that is deformable when inserted between the patient's teeth to make an impression of at least a series of adjacent teeth, while at the same time being sufficiently rigid to maintain the impression. Materials such as wax, polyvinylsiloxane or other suitable hardenable plastics are used. Multiple dental records are formed to create a group of dental records for a particular patient that provide redundancy and accuracy in order to facilitate and verify the subsequent mounting of the dental casts.

At present, a preferred way to mount the dental records so as to re-establish the interrelationship between the patient's actual teeth is to use a first dental record to mount the dental casts to an articulator and then perform a series of indexing tests using different dental records from the group of records to ensure that each record results in the same position of the dental casts.

Dental articulators are expensive pieces of equipment and each articulator tends to have a proprietary mounting scheme for the dental casts. Often the dental casts are made at laboratories using negative impressions and dental records provided by a dentist. Depending on the articulator equipment used by a dentist, it is necessary for the lab to maintain in inventory various articulator devices in order to have available the appropriate equipment for mounting and verify the dental records. The verification of the dental records prior to shipping the completed dental casts back to the dentist requires a considerable investment on the part of the labs in expensive articulator equipment and set up time. In addition, the set up and use of different articulator designs requires a significant investment in training for lab personnel.

### SUMMARY OF THE INVENTION

Accordingly, there is a need for a simple, reliable dental cast handling apparatus that avoids the foregoing problems. The present invention provides a compact unit that is designed to receive dental casts formed for various dental articulator designs in order to verify the accuracy of the dental records associated with the casts or the dental cast mountings.

Accordingly, the present invention provides apparatus for verifying the interrelationship between dental casts of a patient's upper and lower teeth using a group of dental interocclusal records comprising:

a mounting surface with a clamping system to hold one of the upper and lower dental casts in an anchored position in order to receive the other of the dental casts in a supported position with one of the dental interocclusal records insertable between the upper and lower dental casts;

an indexing system associated with the mounting surface for marking the dental cast in the supported position with at least three index marks for the dental interocclusal record;

whereby the interfit of the dental casts is considered accurate if a second interocclusal record of the group results in the same at least three index marks being made to the dental cast in the supported position.

The present invention can be used to check the interrelationship between dental casts using interocclusal records either prior to an initial mounting of the casts on an articulator or subsequent to such a mounting.

### BRIEF DESCRIPTION OF THE DRAWINGS

Aspects of the present invention are illustrated, merely by way of example, in the accompanying drawings in which:

FIG. 1 is rear elevation view of a preferred embodiment of the apparatus of the present invention showing three indexing system arms in the raised working position;

FIG. 1A is a detail cross-section view taken along line 1A-1A of FIG. 1 showing a marking guide slidably received in arm.

FIG. 2 is a top elevation view showing the mounting surface of the apparatus and details of a universal clamping system for retaining dental casts; and

FIG. 3 is a perspective view of an additional mounting surface for optional use with the second dental cast to be positioned in the supported position.

### DESCRIPTION OF THE PREFERRED EMBODIMENTS

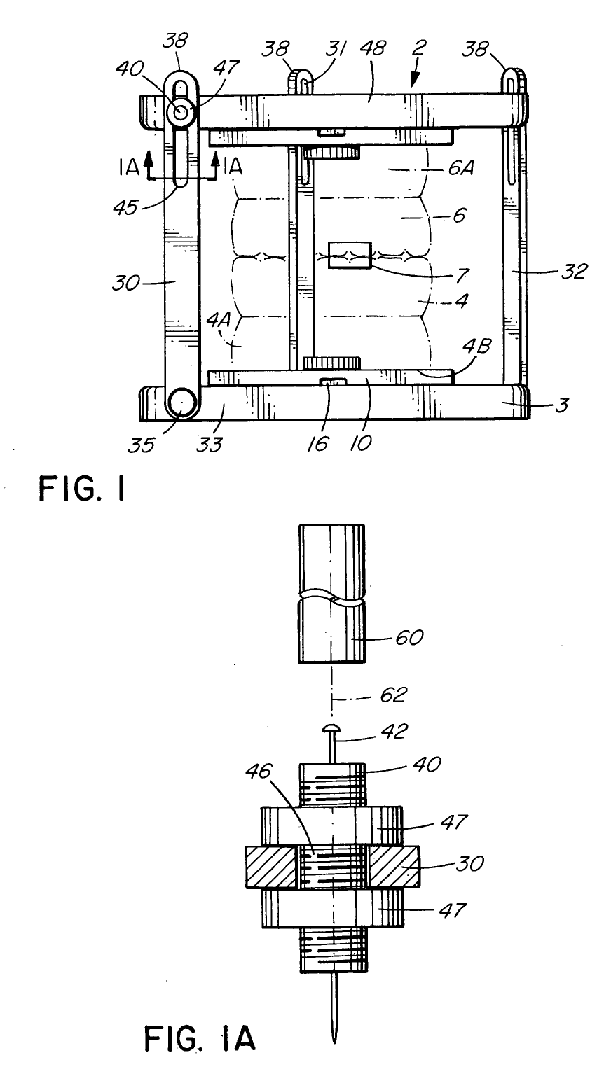

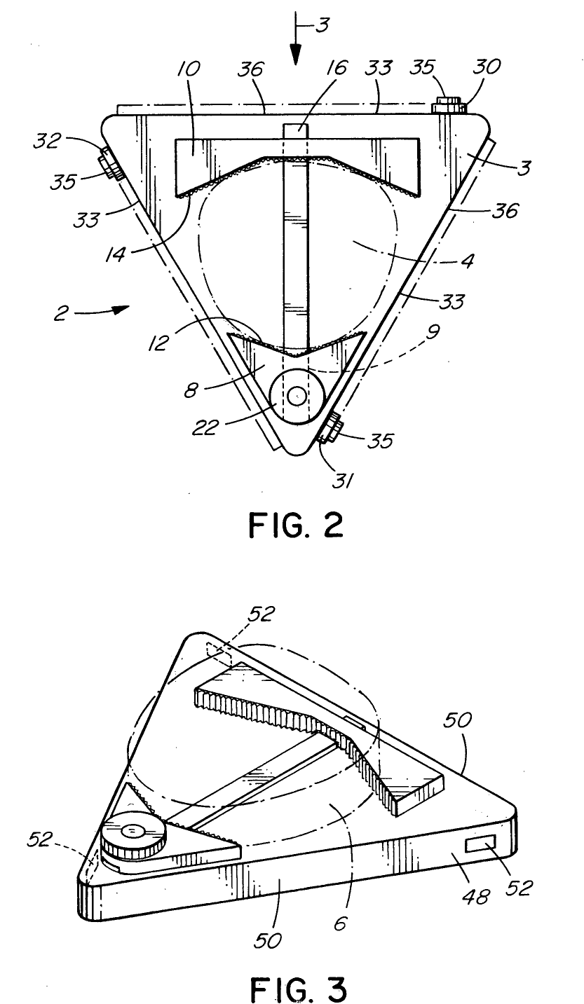

Referring to FIGS. 1 and 2, there is shown a preferred embodiment of apparatus 2 for verifying the interrelationship between dental casts according to the present invention. FIG. 1 is a rear view of the apparatus taken along the sight line indicated by arrow 3 in FIG. 2. The apparatus is usable immediately after the dental casts have been formed if there is concern about the accuracy of the casts or the accuracy of the interocclusal records. The apparatus can also be used after the casts have been preliminarily mounted by the dentist or the laboratory on the articulator of choice to verify the accuracy of the mounted interrelationship. At least two interocclusal records confirm the interrelationship, that is, the dental casts mounted in the articulator equipment accurately reproduce the alignment of a patient's teeth to model the patient's mouth; the device of the present invention therefore confirms the accuracy of the mounting. The resulting articulated and verified model allows a dentist to work outside the confines of the patient's mouth with confidence to create dental prostheses such as crowns, bridges or the like for reliable fitting into the patient's mouth.

The dental cast apparatus 2 comprises a mounting surface 3 with a clamping system to hold either the upper or lower dental cast of a patient. In FIGS. 1 and 2, a lower dental cast 4 is shown by dashed lines retained on mounting surface 3. Lower dental cast 4 is held in an anchored position on mounting surface 3 in order to receive the upper dental cast 6 in a supported position atop the lower dental cast. A dental record 7 is insertable between the upper and lower dental casts in order to begin the process of verifying the dental record using the apparatus of the present invention.

The dental record verification apparatus 2 is intended to be used with dental casts that may be mounted onto all sorts of mounting hardware for attachment to specific dental articulators. Such articulators tend to use proprietary mounting schemes and the apparatus of the present invention relies on a universal clamping system that can accommodate any dental cast.

As best shown in FIG. 2, which is a plan view of the apparatus shown in FIG. 1, the clamping system preferably comprises a pair of spaced clamping blocks 8,10 that are movable with respect to each other to directly engage and hold by friction the perimeter of a pillar portion 4A of dental cast 4 between the blocks. This arrangement avoids most proprietary dental cast mounting schemes for articulators that are generally formed on the base surface 4B of the pillar portion 4A of the dental cast. The clamping blocks include opposed, generally concave surfaces 12 and 14 with a high friction surface to grasp and hold the dental cast therebetween. In the illustrated embodiment, the high friction surface is formed by a series of serrations on concave surfaces 12 and 14. Alternatively, the high friction surface can be formed by a rubber or other high friction material affixed to concave surface 12 and 14.

At least one of the clamping blocks, in this case clamping block 8, is mounted for movement along a clamping rail 16 that extends across mounting surface 3 between the clamping blocks. Preferably, block 8 is formed with a lower channel 9 that receives rail 16. In the illustrated embodiment, clamping block 10 is fixed in position on rail 16 and clamping is achieved by placing the dental cast against block 10 and sliding block 8 into engagement with the cast along rail 16. Movable clamping block 8 includes a locking mechanism in the form of a clamp member to lock the block to the clamping rail. Rotation of knurled knob 22 acts to operate the clamp member to locks block 8 with respect to rail 16.

It will be apparent to a person skilled in the art that alternative clamping arrangements are possible. For example, both clamping blocks can be movable simultaneously with respect to each other to achieve the necessary clamping action with the perimeter of the lower pillar of the dental cast.

Alternatively, the clamping system can comprise a magnet and a magnetically attracted member, such as another magnet or a ferrous surface, in the base 3 and the dental cast to releasably connect the dental cast to the base.

Hook and loop fasteners, such as Velcro® fasteners can also be used to mounted the dental cast to base 3.

In order to carry out its function of verifying dental records associated with a patient's set of upper and lower dental casts, the apparatus of the present invention includes an indexing system linked with mounting surface 3 for marking the dental cast in the supported position with at least three index marks for each dental record. This indexing system is based on the notion that any two records of a group of dental records are considered to be verified if the two dental records result in the same index marks being made to the dental cast in the supported position.

Referring again to FIG. 1, there is shown a preferred indexing system which comprises at least three arms pivotally mounted to mounting surface 3. In the illustrated embodiment, the three arms 30, 31 and 32 are mounted to each side 33 of a generally triangular mounting surface 3. For compact storage purposes, each arm 30. 31 and 32 is preferably pivotable about pivot point 35 between a stowed position 36 parallel to one of the side edges 33 of the mounting surface 3 (shown by dashed lines in FIG. 2) and a working position 38 upstanding from the mounting surface in a generally vertical orientation.

In the illustrated embodiment, each arm 30, 31, 32 includes a marking guide for marking an index mark on the dental cast 6 in the supported position atop the clamped dental cast 4. Preferably, as best shown in FIG. 1A which represents a cross-section through arm 30 taken along line 1A-1A, the marking guide comprises a tubular member 40 to slidably receive and guide a marking tool in the form of a pin member 42. Pin 42 is inserted through tubular member 40 to mark the upper dental cast with a pin prick. Alternative marking tools can be used. For example, the marking tool can be a pencil or marker pen. Any tool that places a readily identifiable mark on dental cast 6 in the supported position can be employed.

To assist in proper vertical positioning of the tubular member 42 of the marking guide with respect to dental cast 6, the marking guide is slidably received in a slot 45 in each arm. To ensure that the marking guide maintains its position within slot 45, a guide locking system is provided. In the illustrated embodiment, this locking system comprises an threaded section 46 on tubular member 40 and a pair of corresponding threaded rings 47 received on the threaded section. Threaded rings 47 are tightened against either side of the arm to clamp the marking guide in place in slot 45. Alternatively, the marking guide can be dimensioned to be a tight friction fit within the slot so that the tubular member will tend to stay at the position to which it is moved.

Other configurations of the mounting surface 3 and the indexing arms are possible, however, it is important that at least three index marks be made. The three index marks define a plane and allow the apparatus of the present invention to verify the horizontal and vertical alignment of the dental casts. Preferably, the three arms 30, 31 and 32 are spaced as widely apart as possible as the greater the distance between the marking positions for the three index marks, the greater will be any misalignment between index marks created by a correct and an inaccurate dental record to make an incorrect dental mounting more readily detectable. Additional arms can be included to provide additional data points for verification, however, a triangular mounting surface with three arms provides a lightweight, compact unit with a minimum of moving parts that permits reliable verification.

The foregoing description discusses an embodiment of the present invention in which the upper dental cast 6 supported on the lower dental cast 4 is marked directly by a marking tool. FIG. 3 illustrates an additional, upper mounting surface 48 to which upper dental cast 6 may be mounted which provides an alternative marking surface for the marking tool. Additional upper mounting surface 48 includes a clamping system similar to that of mounting surface 3 for receiving dental cast 6. The upper mounting surface 48 also preferably has the same shape as mounting surface 3. In the case of the illustrated embodiment, this is a triangular shape. In addition, each side 50 of mounting surface 48 include an indexing area 52 for marking by the marking tool. Each indexing area 52 comprises a markable surface positioned on side 50 to be alignable with tubular member 40 of the marking guide. For example, indexing area 52 may be a removable adhesive label that can be replace after each dental record verification procedure.

Depending on the dimensions of the dental casts, it may be necessary to pivot arms 30, 31, 32 to an intermediate position less than vertical such that the marking guide can be moved to a position within slot 45 that will permit pin 42 to engage the dental cast directly or indexing area 52 if an upper mounting surface 48 is employed. To accommodate such an intermediate position of the arms, pivot point 35 may be formed with a clamping system, such as a knurled knob tightenable onto a threaded shaft defining the pivot point in order to lock each arm in its intermediate position.

The apparatus of the present invention provides an inexpensive, compact tool for use with dental casts and interocclusal records. Base 3 of the apparatus can be fitted with a hook and look fastener or other suitable attachment means for releasably affixing the unit in a convenient storage location suspended from beneath a shelf or desk surface.

Using the apparatus of the present invention initially involves mounting one of a pair of a patient's upper or lower dental casts to mounting surface 3 using clamping blocks 8 and 10. The dental casts can be used with the apparatus of the present invention either before or after a preliminary initial mounting of the casts on an articulator. Generally, the lower dental cast will be placed on mounting surface 3 with the upper dental cast being supported thereon to mimic the usual orientation of the patient's teeth, however, this is not mandatory, and the upper dental cast can be mounted to the base to support the lower dental cast in an upside down orientation.

Arms 30, 31 and 32 are preferably in their stowed position 36 at this stage to allow full access to the clamping mechanism. After clamping dental cast 4 in position, the arms are pivoted to their upright position. A dental interocclusal record 7 is then placed on mounted dental cast 4 in the position at which the record was initially made in the patient's mouth, and the upper dental cast 6 is positioned atop the dental record and the lower mounted dental cast. The upper dental 6 cast may be mounted to additional mounting surface 48 prior to positioning atop lower dental cast 4 or the upper dental cast may be positioned without the mounting surface 48. At this stage, the apparatus appears as shown in FIG. 1 (with mounting surface 48 attached to upper dental cast 6). The dental record 7 is used to position the upper and lower dental casts with respect to each other according to their alignment in the patient's mouth. Each marking guide is positioned by sliding in slot 45 to be generally located adjacent the upper dental cast 6 or the appropriate indexing area 52 of mounting surface 48. A marking tool such as marking pin 42 is then inserted through tubular member 40 at each post to make an index mark directly on the upper dental cast 6 or on the associated indexing area 52 of mounting surface 48. Without adjusting the established positions of the arms and the tubular members of the marking guides, another dental record 7 is inserted between the dental casts, the casts repositioned and the marking procedure repeated. If the index marks made in the second marking procedure are identical to the marks made in the initial procedure, the two dental records can be considered to be verified and the user can be confident the dental cast mountings are accurate and reproduce the interrelationship of the patient's teeth. Instead of a second marking procedure, once a set of three index marks has been made for a first dental record, a subsequent dental record can be checked against the first dental record by using a unit for generating a laser beam, such as a laser pointer 60, aligned with tubular member 40. If the laser illuminates the existing index mark associated with each arm, the two dental records can be considered verified.

In an alternative procedure, instead of inserting marking pin through tubular member 40 to make a mark, laser pointer unit 60 can be aligned to direct laser beam 62 through the interior of tubular member to illuminate a point on the upper dental cast 6 or the associated indexing area of mounting surface to indicate the position of the index mark (FIG. 1A). Marking pin 5 or another suitable marking tool, such as a pen, can then be used to make a permanent index mark using the laser light as a guide.

The verification process of the dental casts using dental or interocclusal records can be performed before the dental casts have been initially mounted in a desired articulator, that is, without articulator mounting hardware, or after such a mounting when the dental casts have been customized to include the proprietary mounting hardware for the particular articulator selected. Additional dental records 7 of a group of records can be verified in the same manner, although this is generally not necessary; once two dental records of a group are verified, the verification process can be stopped. It is important that a dentist takes at least three dental records of the patient to have backup records in case the first two do not match.

Although the present invention has been described in some detail by way of example for purposes of clarity and understanding, it will be apparent that certain changes and modifications may be practised within the scope of the appended claims.

We claim:

1. Apparatus for verifying the interrelationship between dental casts of a patient's upper and lower teeth using a group of dental interocclusal records comprising:
a mounting surface with a clamping system to hold one of the upper and lower dental casts in an anchored position in order to receive the other of the dental casts in a supported position with one dental interocclusal record of the group insertable between the upper and lower dental casts;
an indexing system associated with the mounting surface for marking the dental cast in the supported position with at least three index marks for the one dental interocclusal record;
whereby the interrelationship of the dental casts is considered accurate if a second dental interocclusal record of the group results in the same at least three index marks being made to the dental cast in the supported position.

2. Apparatus as claimed in claim 1 in which the indexing system comprises at least three, spaced arms, each arm being pivotally mounted to the mounting surface and movable between a stowed position parallel to a side edge of the mounting surface and a working position upstanding from the mounting surface, and each arm including a marking guide for marking one of the at least three index marks on the dental cast in the supported position when the at least one arm is in the working position.

3. Apparatus as claimed in claim 2 in which the marking guide comprises a tubular member to slidably receive and guide a marking tool.

4. Apparatus as claimed in claim 3 in which the marking tool is a pin member.

5. Apparatus as claimed in claim 3 in which the marking tool comprises a unit for generating a laser beam to indicate the index mark

6. Apparatus as claimed in claim 2 in which each arm includes a slot formed therein to slidably receive the marking guide.

7. Apparatus as claimed in claim 6 n which the mounting surface is generally triangular with three sides and each arm is positioned to extend along one of the sides of the mounting surface when the arm is in the stowed position.

8. Apparatus as claimed in claim 1 in which the clamping system comprises a pair of spaced clamping blocks movable with respect to each other to grip and hold one of the upper and lower dental casts therebetween.

9. Apparatus as claimed in claim 8 in which at least one of the clamping blocks is mounted for movement along a clamping rail extending between the clamping blocks.

10. Apparatus as claimed in claim 9 in which one of the clamping blocks is fixed in position on the base and the other clamping block is movable

11. Apparatus as claimed in claim 10 including a locking mechanism to lock the clamping block that is movable to the clamping rail.

12. Apparatus as claimed in claim 1 in which the clamping system comprises one of a magnet and a magnetically attracted member in the base to releasably engage a corresponding member in surface in the dental cast.

13. Apparatus as claimed in claim 2 including an additional mounting surface with a clamping system for receiving the other of the dental casts.

14. Apparatus as claimed in claim 13 in which the additional mounting surface includes at least three indexing areas for receiving the at least three index marks.

15. Apparatus as claimed in claim 14 in which the additional mounting surface is generally triangular with three sides, and one of the at least three indexing area is formed on each side for marking with the marking guide.

16. Apparatus for verifying the accuracy of the mounting of dental casts of a patient's upper and lower teeth using a group of dental interocclusal records after the dental casts have been initially mounted in a dental articulator comprising:
a mounting surface with a clamping system to hold one of the upper and lower dental casts in an anchored position in order to receive the other of the dental casts in a supported position with one of the dental interocclusal records of the group insertable between the upper and lower dental casts;
an indexing system associated with the mounting surface for marking the dental cast in the supported position with at least three index marks for each dental record;
whereby the mounting of the dental casts is considered accurate if a second dental interocclusal record of the group results in the same at least three index marks being made to the dental cast in the supported position.

17. Apparatus as claimed in claim 16 including an additional mounting surface with a clamping system for receiving the other of the dental casts.

18. Apparatus as claimed in claim 17 in which the additional mounting surface includes at least three indexing areas for receiving the at least three index marks.

19. Apparatus as claimed in claim 18 in which the additional mounting surface is generally triangular with three sides, and one of the at least three indexing areas is formed on each side for marking with the marking guide.
